(19) United States
(12) Patent Application Publication
(10) Pub. No.: US 2011/0292062 A1
(43) Pub. Date: Dec. 1, 2011

(54) IMAGE PROCESSING APPARATUS, METHOD, AND STORAGE MEDIUM STORING A PROGRAM

(75) Inventor: Takayuki HIROTANI, Tokyo (JP)

(73) Assignee: CASIO COMPUTER CO., LTD., Tokyo (JP)

(21) Appl. No.: 13/112,169

(22) Filed: May 20, 2011

(30) Foreign Application Priority Data
May 28, 2010 (JP) 2010-122794

(51) Int. Cl. G09G 5/00

(52) U.S. Cl. 345/581

(57) ABSTRACT

A photo frame 1 controls an initial frame storing unit 111 that stores image data of an image, a painting-like conversion contents storing unit 113 that stores priorities for a plurality of characteristic regions constituting the image, a display data generation unit 105 that extracts image data of the plurality of characteristic regions from the image data stored in the initial frame storing unit 111 and generates image data of a display image, and a display unit 41 and thereby progressively displays the image in units of the characteristic regions of the image according to the priorities stored in the painting-like conversion contents storing unit 113 based on the image data of the plurality of characteristic regions extracted and generated by the display data generation unit 105.

This application is based upon and claims the benefit of priority from the prior Japanese Patent Japanese Patent Application No. 2010-122794 filed on May 28, 2010, and the entire contents of which are incorporated herein by reference.

### BACKGROUND OF THE INVENTION

1. Field of the Invention

The present invention relates to an image processing apparatus, a method, and a storage medium having stored therein a program, and more particularly to a technique of displaying images.

2. Related Art

As disclosed in Japanese Patent Application Publication No. H11-344771, there is generally known a display method of displaying an image in a slideshow format in which a plurality of images are switched in turn and displayed one after another. As a conventional slideshow format display technique of switching a plurality of images in turn and displaying the images one after another, there is known an image display apparatus that displays a plurality of images in the slideshow format after the images are sorted by title, for example. As disclosed in Japanese Patent Application Publication No. 2000-067057, there is also known a sequential image display apparatus that displays a plurality of images in a slideshow format after the images are sorted according to similarity. Furthermore, as disclosed in Japanese Patent Application Publication No. 2005-167689, there is proposed a display method of carrying out special effects such as fade effect, wipe effect, or overlap effect in order to make distinguishable a separation between neighboring images.

However, the above-described techniques disclosed in Japanese Patent Application Publication Nos. H11-344771 and 2000-067057 only determine the sequence of images to be displayed before the images are displayed, and thus, no slideshow effect other than displaying the images in the display order can be obtained.

On the other hand, for example, when a high artistic image is switched and displayed as in the case where a painting-like converted image B2 is displayed immediately after a photo image A, as shown in FIG. 9, the use of special effects such as fade effect, wipe effect, or overlap effect described in Japanese Patent Application Publication No. 2005-167689 is indeed effective in that it provides a showy view while the image is viewed. However, prolonging a period of time before one image is displayed may only waste a user's viewing time, and bore the user. Thus, a method of displaying an image is desired that can effectively display the image in a sophisticated manner, entertaining a user while the image is displayed.

The present invention has an object of providing an image processing apparatus, method, and storage medium having stored thereon a program that can carry out a display method that effectively displays the image in a sophisticated manner, thereby entertaining a user while the image is displayed.

### SUMMARY OF THE INVENTION

In accordance with a first aspect of the present invention, there is provided an image processing apparatus for causing an image to be displayed, comprising:

a priority storing unit that stores priorities for a plurality of characteristic regions constituting an image;

an image data extracting unit that extracts image data of the plurality of characteristic regions from image data of an image; and

an image display control unit that controls an image display unit to progressively display the image in units of the characteristic regions, in accordance with priorities stored in the priority storing unit, based on the image data of the plurality of characteristic regions extracted by the image data extracting unit from the image data of the image.

In accordance with a second aspect of the present invention, there is provided an image processing method for causing an image to be displayed, comprising:

a priority storing step of storing priorities for a plurality of characteristic regions constituting an image;

an image data extracting step of extracting image data of the plurality of characteristic regions from image data of an image; and

an image display control step of controlling an image display unit to progressively display the image in units of the characteristic regions, in accordance with priorities stored in the priority storing step, based on the image data of the plurality of characteristic regions extracted in the image data extracting step from the image data of the image.

In accordance with a third aspect of the present invention, there is provided an storage medium having stored therein an image processing program causing a computer to control an image display unit to display an image, the program being executable by the computer to function as:

a priority storing unit that stores priorities for a plurality of characteristic regions constituting an image;

an image data extracting unit that extracts image data of the plurality of characteristic regions from image data of an image; and

an image display control unit that controls an image display unit to progressively display the image in units of the characteristic regions, in accordance with priorities stored in the priority storing unit, based on the image data of the plurality of characteristic regions extracted by the image data extracting unit from the image data of the image.

According to the present invention, it is possible to display images in a sophisticated and entertaining manner.

### BRIEF DESCRIPTION OF THE DRAWINGS

FIG. 1 is a block diagram showing a hardware configuration of a photo frame according to one embodiment of the present invention;

FIG. 2 is a functional block diagram showing a functional configuration of a data processing unit of the photo frame of FIG. 1;

FIG. 3 is a diagram illustrating a brief overview of an image display in slideshow format carried out by the data processing unit of FIG. 2;

FIG. 4 is a diagram illustrating one example of a display method of displaying an image in slideshow format carried out by the data processing unit of FIG. 2;

FIG. 5 is a flowchart showing one example of flow of slideshow processing including painting-like conversion processing carried out by the data processing unit of FIG. 2;

FIG. 6 is a diagram showing relation between image generation in slideshow format and the function of each constituent unit of the data processing unit of FIG. 2;

FIG. 7 is a diagram showing examples of other display methods in slideshow format carried out by the data processing unit of FIG. 2;

FIG. 8 is a diagram showing one example of a painting-like conversion processing contents table stored in the painting-like conversion contents storing unit of the data processing unit of FIG. 2; and

FIG. 9 is a diagram showing various appearances of a conventional slideshow.

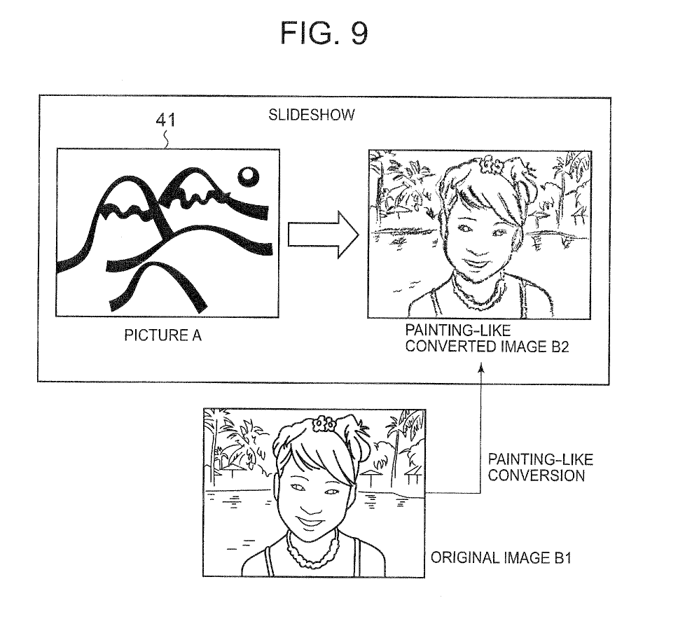

### DETAILED DESCRIPTION OF THE INVENTION

In the following, an image processing apparatus according to one embodiment of the present invention will be described with reference to the drawings. Though a photo frame is used as an example of the image processing apparatus, the image processing apparatus can be any kind of apparatus having a function of controlling an image display device to display images.

In the following, one embodiment of the present invention will be described with reference to the drawings.

### [Configuration of a Photo Frame]

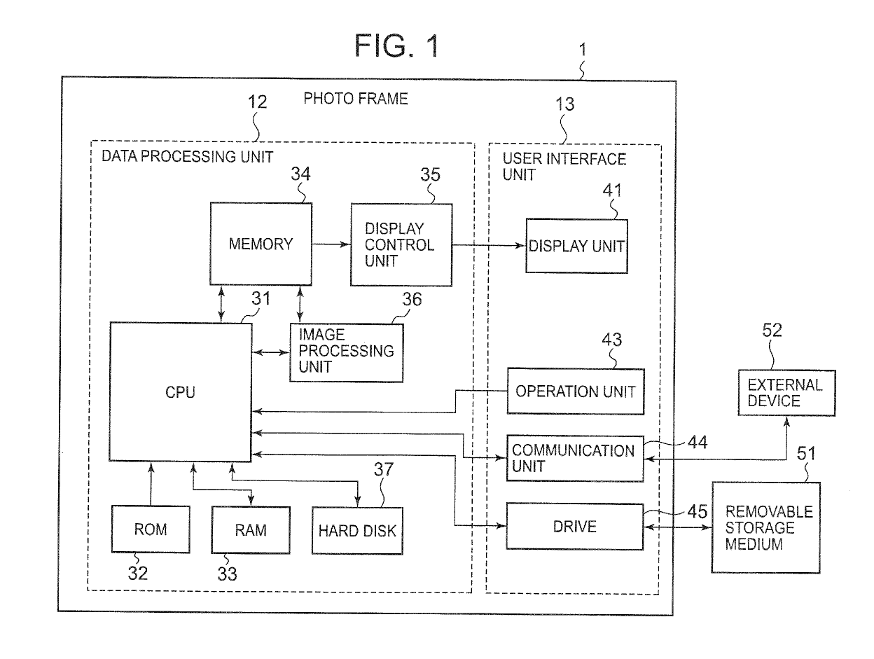

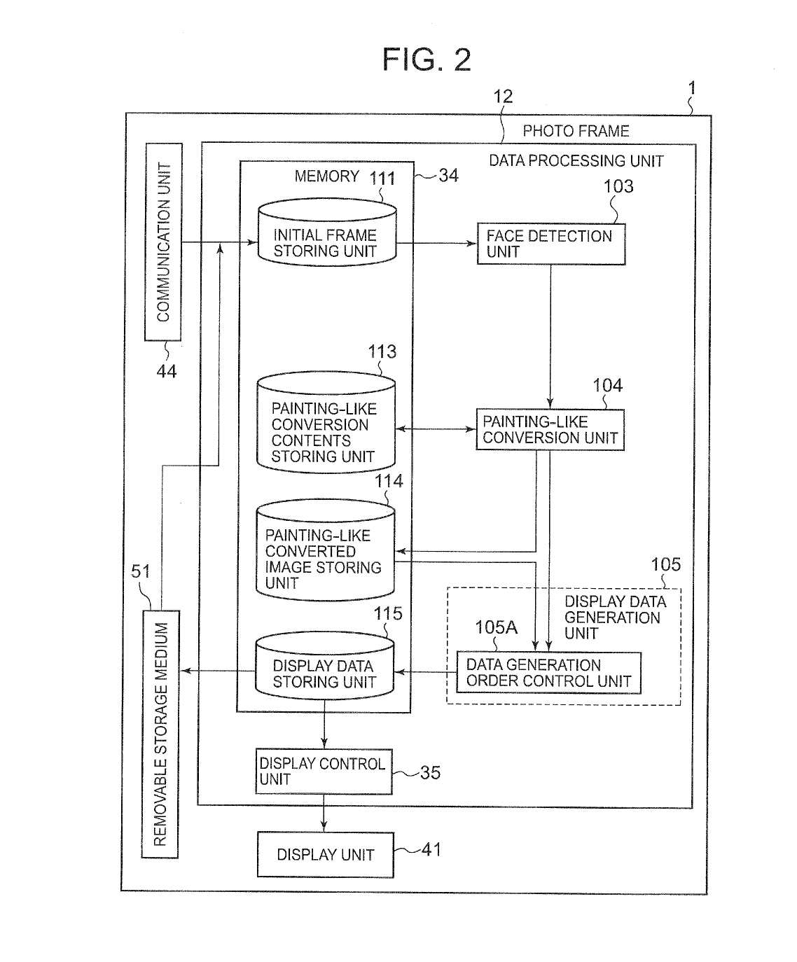

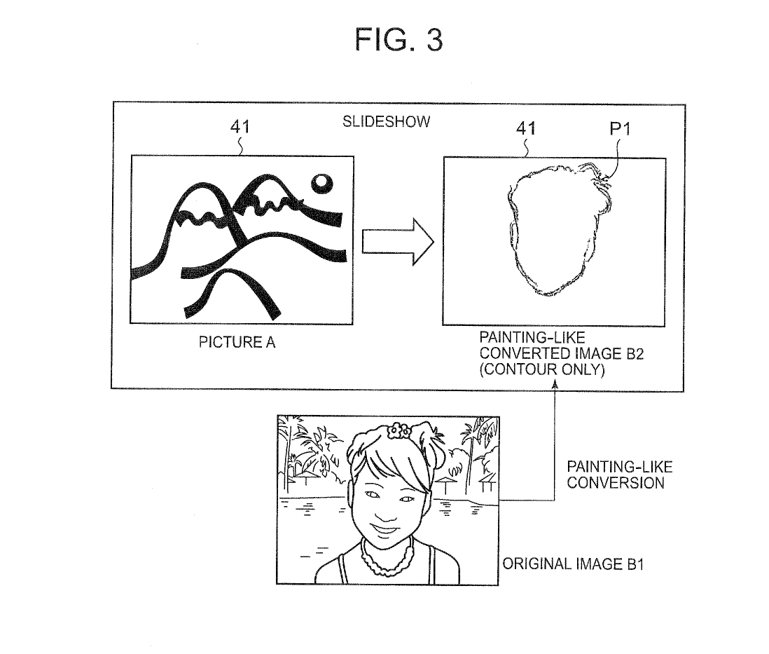

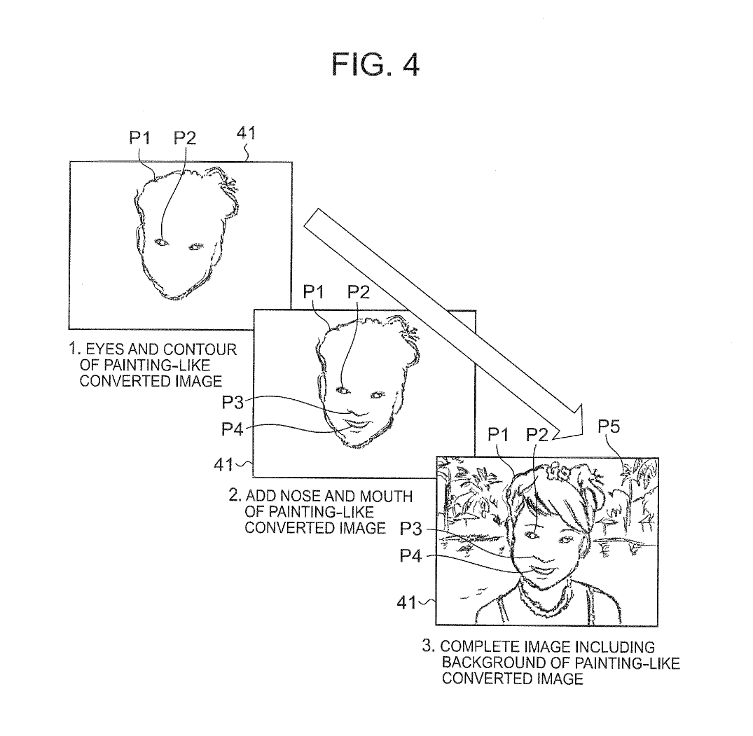

With reference to FIGS. 1 to 4, a photo frame 1 according to one embodiment of the present invention will be described. FIG. 1 is a block diagram showing an internal hardware configuration of the photo frame 1. FIG. 2 is a functional block diagram showing a functional configuration of the data processing unit 12 of the photo frame 1. FIG. 3 is a diagram illustrating an outline of a display method of displaying an image in a slideshow format carried out by the data processing unit 12. FIG. 4 is a diagram illustrating one example of a display method in slideshow format carried out by the data processing unit 12.

As shown in FIG. 1, the photo frame 1 is provided with a data processing unit 12, and a user interface unit 13.

The data processing unit 12 includes a CPU (Central Processing Unit) 31, a ROM (Read Only Memory) 32, a RAM (Random Access Memory) 33, a memory 34, a display control unit 35, and an image processing unit 36.

The CPU 31 executes various processes according to programs that are stored in the ROM 32. The photo frame 1 of the present embodiment has, as operation mode, a slideshow mode of switching a plurality of images and displaying the images one after another in turn, which will be described later, and a slideshow setting mode of setting the slideshow mode. In the slideshow setting mode of the photo frame 1 of the present embodiment, a user can specify settings of various processes executed in the slideshow mode. The ROM 32 stores various programs required to execute various processes in the slideshow setting mode and the slideshow mode and to implement various functions. The various processes executed in the slideshow mode and the slideshow mode include, for example, face detection processing and painting-like conversion processing, which will be described later. The various functions include, for example, functions of the display control unit 35, the image processing unit 36, a display unit 41, an operation unit 43, a communication unit 44, and a drive 45. This means that various functions including the display control unit 35, the image processing unit 36, the display unit 41, the operation unit 43, the communication unit 44, and the drive 45, and various processes in the slideshow setting mode and the slideshow mode including face detection processing and painting-like conversion processing, which will be described later, are realized by the CPU 31 executing the processes according to the programs stored in the ROM 32.

The RAM 33 stores data and the like necessary for the CPU 31 to execute the various processes as appropriate.

The memory 34 is constituted by a DRAM (Dynamic Random Access Memory), a ROM (Read Only Memory) and the like. The DRAM temporarily stores image data outputted from, for example, an image sensor (not shown), and also constitutes a work area of the CPU 31. The ROM may store contents of the painting-like conversion processing, image data which is required for various types of image processing, parameters, values of various flags, threshold values, and the like. The memory 34 also includes a display memory area for storing and reading image data (hereinafter, referred to as “display data”) to be displayed.

The display control unit 35 reads display data stored in the display memory area of the memory 34 and executes control that causes the display unit 41 of the user interface unit 13 to display an image (hereinafter, referred to as “display image”) expressed by the display data. For example, the display control unit 35 generates RGB signals based on the display data, supplies the RGB signals to the display unit 41, and thereby causes the display unit 41 to display the display image.

The image processing unit 36 is constituted by a DSP (Digital Signal Processor) or the like and executes various types of image processing such as white balance correction processing or gamma correction processing on the image data stored in the memory 34. In the present embodiment, the image processing unit 36 executes at least a part of various types of image processing carried out by a face detection unit 103 and a painting-like conversion unit 104, which will be described later with reference to FIG. 2, and the CPU 31 executes a part of the rest thereof. This means that, in the present embodiment, the face detection unit 103 and the painting-like conversion unit 104, which will be described later, are configured as a combination of the CPU 31 and the image processing unit 36 as hardware and the program (software) stored in the ROM 32 as software.

The user interface unit 13 includes the display unit 41 constituted by a display or the like provided on the chassis of the photo frame 1, the operation unit 43 that receives a user's instruction operation, the communication unit 44 that controls communication with an external device 52, and the drive 45 that reads data from and writes data to a removable storage medium 51 having image data stored therein. The removable storage medium 51 stores the image data generated by the data processing unit 12. The removable storage medium 51 may be realized by a memory card or the like, for example, and constitutes a storing unit.

It is possible to output the RGB signal generated by the display control unit 35 to an external device 52 via the communication unit 44 of the user interface unit 13 or using the removable storage medium 51 controlled by the drive 45. With this, it becomes possible to display the display image by way of an external device 52 such as a TV set, a personal computer, or a projector.

The operation unit 43 includes, for example, a power button, a zoom key, a mode switch key, and the like. The operation unit 43 generates an operation signal in accordance with each operation, and sends the signal to the data processing unit 12. For example, when a user operates the mode switch key to designate the slideshow mode, an operation signal is sent to the data processing unit 12, and the CPU 31 switches the operation mode to the slideshow mode. Similarly, when the user operates the mode switch key to designate the slideshow setting mode, the CPU 31 switches the operation mode to the slideshow setting mode. Likewise, in response to operations of any other elements of the operation unit 43 by the user, various operation signals are sent to the data processing unit 12, and the CPU 31 executes processes according to respective operation signals.

In the following, a functional configuration of the data processing unit 12 will be described with reference to FIG. 2.

The data processing unit 12 includes the memory 34, the display control unit 35, the face detection unit 103, the painting-like conversion unit 104, and a display data generation unit 105. In the memory 34 of the data processing unit 12, an initial frame storing unit 111, a painting-like conversion contents storing unit 113, a painting-like converted image storing unit 114, and a display data storing unit 115 are provided. The image processing apparatus according to the present invention may be configured by the data processing unit 12 alone.

In the initial frame storing unit 111, image data of a frame image read from the removable storage medium 51 or image data of a frame image acquired from the communication unit 44 are also stored as image data of an initial frame image.

The painting-like conversion contents storing unit 113 stores various contents of the painting-like conversion processing. Though not shown, each content of the painting-like conversion processing may also include progressive display order of characteristic regions in the slideshow mode, i.e., a display style specifying a priority for each characteristic region, and detailed parameters used in the painting-like conversion processing. The painting-like conversion contents storing unit 113 constitutes a priority storing unit.

The face detection unit 103 extracts characteristic points from image data stored in the initial frame storing unit 111 and detects a face region, face size, and the like of a subject. For example, by way of characteristic points extraction processing disclosed in Japanese Patent Publication No. 2001-16573, characteristic points of a face such as end points of brows, eyes, nose, and mouth, contour points of the face, top points of a head, and bottom points of a chin are extracted first. By acquiring peripheral edge information from the characteristic points thus detected, the face detection unit 103 can identify regions of the brows, the eyes, the nose, and the mouth as characteristic regions, determine the boundaries thereof as contours, and acquire position information thereof.

As another method of the face detection unit 103 of detecting a face and determining characteristic regions, various methods are applicable such as a method that detects a face region from image data based on brightness and generates facial region information from image information of the detected face region. However, since the technique of face detection processing is publicly known, further details will not be described herein. The method of the face detection unit 103 of detecting a face and determining characteristic regions and a facial contour is not limited to the methods described above, and any reasonable method may be employed.

The painting-like conversion unit 104 carries out painting-like conversion processing on image data stored in the initial frame storing unit 111 according to content of the painting-like conversion processing that is selected from among the contents of the painting-like conversion processing stored in the painting-like conversion contents storing unit 113. Such painting-like conversion processing can also be executed by commercially available software such as Photoshop (registered trademark), a product of Adobe Systems Incorporated.

In the present embodiment, in the slideshow setting mode, a user can specify content of the painting-like conversion processing stored in the painting-like conversion processing contents storing unit 113 by operating the operation unit 43. In this way, a user can set content of the painting-like conversion processing carried out by the painting-like conversion unit 104 in the slideshow setting mode. Furthermore, in the slideshow setting mode, a user can specify parameters stored in the painting-like conversion processing contents storing unit 113 by operating the operation unit 43. In this way, in the slideshow setting mode, a user can adjust detailed parameters used in such painting-like conversion processing as well. The painting-like conversion unit 104 carries out the painting-like conversion processing according to the content of the painting-like conversion processing and detailed parameters thus specified.

More specifically, the painting-like conversion unit 104 converts image data stored in the initial frame storing unit 111 into image data indicative of an image resembling a specific style of painting according to content of the painting-like conversion processing and parameters selected from among the contents of the painting-like conversion processing stored in the painting-like conversion contents storing unit 113. When the painting-like conversion unit 104 converts image data into image data indicative of a painting-like image, the whole image data may be converted at once, or image data corresponding to a portion indicative of each characteristic region may be partially converted as required.

Here, a painting-like image can be defined based on an impression therefrom and classified into various styles such as, for example, “Japanese painting-like”, “Western painting-like”, “watercolor painting”, “ink painting-like”, “pen drawing-like”, or “Gogh-like”. As parameters used for the painting-like conversion processing, for example, contrast, brightness, color density, hue, sharpness, and if necessary, degree of noise reduction filter effect, color temperature, gamma value of gamma correction, and/or the like, may be employed. It is possible to designate any one of such parameters or any combination thereof for the painting-like conversion processing. However, the present invention is not limited to this and may include any kind of parameters appropriate for expressing the painting-like image described above.

In the present embodiment, it is assumed that the optimal combination of parameters described above is predetermined for each type of painting-like image and is included in the contents of the painting-like conversion processing stored in the painting-like conversion contents storing unit 113.

The setting for each type of painting-like image stored in the painting-like conversion contents storing unit 113 may be defined by a combination of a plurality of parameters, such as contrast, brightness, color density, hue, or sharpness. For example, parameters which cause the image to be unshaded and the color tone thereof to become monotonous may be set for a “Japanese painting-like” image. On the other hand, parameters which cause the image to be emphasized by shading and the color tone thereof to become enriched may be set for “Western painting-like” image.

The image data of a frame image thus acquired after carrying out the painting-like conversion processing on the image data of the initial frame image is temporarily stored in the painting-like converted image storing unit 114. The frame image represented by the image data thus acquired by the painting-like conversion unit 104 after carrying out the painting-like conversion processing is hereinafter referred to as “painting-like converted image”, and the initial frame image represented by the image data, on which the painting-like conversion unit 104 has carried out the painting-like conversion processing to acquire the image data of the “painting-like converted image”, is hereinafter referred to as “original image”.

The painting-like converted image storing unit 114 stores the painting-like converted image data acquired by the painting-like conversion processing carried out by the painting-like conversion unit 104. The initial frame storing unit 111 and the painting-like converted image storing unit 114 constitutes an image storing unit.

The display data generation unit 105 includes a data generation order control unit 105A.

The data generation order control unit 105A determines priorities, i.e., the order of progressively displaying characteristic regions according to a display style stored in the painting-like conversion contents storing unit 113. The display style can be set in the slideshow setting mode by a user operating the operation unit 43 to select content of the painting-like conversion processing stored in the painting-like conversion contents storing unit 113. In the present embodiment, a facial contour alone is first displayed. Next, an eye region is incrementally displayed, and then nose and mouth regions are incrementally displayed. Finally, the complete image including a background is displayed. This means that the facial contour is specified as a characteristic region having the highest priority, and then the eyes, the nose, the mouth, and the complete image including background are specified as characteristic regions in order of priority. However, this is merely an example, and any setting is possible by selecting content of the painting-like conversion processing stored in the painting-like conversion contents storing unit 113.

The display data generation unit 105 extracts image data of each characteristic region from the painting-like converted image data stored in the painting-like converted image storing unit 114 and generates data of an image, herein referred to as “display data” as well, to be displayed on the display unit 41.

More specifically, the display data generation unit 105 acquires the image data corresponding to eyes, nose, and mouth regions and contours as image data of characteristic regions from the painting-like converted image data stored in the painting-like converted image storing unit 114 based on position information of eyes, nose, and mouth regions and contours detected by the face detection unit 103. The display data generation unit 105 generates display data (image data of an image to be displayed on the display unit 41) from the image data of each characteristic region of the painting-like converted image thus acquired. The order of progressively displaying the characteristic regions of the painting-like converted image conforms to the order determined by the data generation order control unit 105A. The face detection unit 103 and the display data generation unit 105 constitute an image data extraction unit.

The display data storing unit 115 sequentially stores the display data generated by the display data generation unit 105. This means that the display data stored in the display data storing unit 115 is updated each time the display data generation unit 105 incrementally generates display data in the order of facial contour, eyes, nose, mouth, and the complete image including background.

The display control unit 35 controls the display unit 41 each time the display data stored in the display data storing unit 115 is updated, to switch the image displayed on the display unit 41 based on the updated display data. With this, the image displayed on the display unit 41 is updated each time the display data generation unit 105 generates new display data. The display unit 41 constitutes an image display unit.

FIG. 3 shows a brief overview of the image display in slideshow format carried out by the data processing unit 12. Here, a photo image A is displayed on the display unit 41 as a present image. The image to be displayed in place of the photo image A is assumed to be a painting-like converted image B2 that has been generated by applying the painting-like conversion processing to image data of the original image B1. As shown in FIG. 3, when the painting-like converted image B2 is to be displayed in place of the photo image A, the complete image is displayed not at once but the facial contour P1 of the painting-like converted image B2 is first displayed on the display unit 41.

More specifically, in FIG. 3, the display data storing unit 115 stores the image data of the photo image A as the present image. The display control unit 35 causes the display unit 41 to display the photo image A based on the image data of the photo image A.

Next, the display control unit 35 causes the display unit 41 to display in place of the photo image A an image of image data, to which the painting-like conversion processing has been applied, i.e., the image corresponding only to the facial contour P1 of the painting-like converted image B2. More specifically, the display data generation unit 105 acquires image data corresponding to the facial contour P1 of the painting-like converted image B2 from the painting-like converted image storing unit 114 based on the position information on the original image B1 acquired by the face detection unit 103 and stores it as display data in the display data storing unit 115. The display control unit 35 controls the display unit 41 to display the image of the facial contour P1 alone, based on the display data of the painting-like converted image B2 thus stored in the display data storing unit 115. By displaying the facial contour, the image about to be displayed (the painting-like converted image B2) can be roughly presented to the user.

FIG. 4 shows one example of an image display method subsequently carried out by the data processing unit 12. Following the facial contour P1 of the painting-like converted image B2 of FIG. 3, the eyes P2, next the nose P3 and the mouth P4, finally the complete image P5 including background are progressively displayed on the display unit 41.

More specifically, the display data generation unit 105 acquires image data corresponding to the region of the eyes P2 from the painting-like converted image storing unit 114, following the facial contour P1 of the painting-like converted image B2, based on the position information acquired by the face detection unit 103 and stores it along with the already acquired image data of the facial contour P1 as the display data in the display data storing unit 115. Alternatively, instead of overlaying the image data of the region of the eyes P2 on the image data of the facial contour P1, the display data generation unit 105 may acquire image data corresponding to both of the facial contour P1 and the region of the eyes P2 from the painting-like converted image storing unit 114 and store it as the display data in the display data storing unit 115. The display control unit 35 controls the display unit 41 to display thereon the image of the facial contour P1 and the region of the eyes P2 based on the display data stored in the display data storing unit 115.

Furthermore, the display data generation unit 105 acquires image data corresponding to the region of the nose P3 from the painting-like converted image storing unit 114, following the facial contour P1 and the region of the eyes P2 of the painting-like converted image B2, based on the position information acquired by the face detection unit 103 and stores it along with the already acquired image data of the facial contour P1 and the region of the eyes P2, as the display data in the display data storing unit 115. Alternatively, instead of overlaying the image data of the region of the nose P3 on the image data of the facial contour P1 and the region of the eyes P2, the display data generation unit 105 may acquire image data corresponding to the facial contour P1 and the regions of the eyes P2 and the nose P3 from the painting-like converted image storing unit 114 and store it as the display data in the display data storing unit 115. The display control unit 35 controls the display unit 41 to display thereon the image of the facial contour P1 and the regions of the eyes P2 and the nose P3 based on the display data stored in the display data storing unit 115.

Subsequently, the display data generation unit 105 acquires image data corresponding to the region of the mouth P4 from the painting-like converted image storing unit 114, following the facial contour P1 and the regions of the eyes P2 and the nose P3 of the painting-like converted image B2, based on the position information acquired by the face detection unit 103 and stores it along with the already acquired image data of the facial contour P1, the eyes P2, and the nose P3, as the display data in the display data storing unit 115. Alternatively, instead of overlaying the image data of the region of the mouth P4 on the image data of the facial contour P1 and the regions of the eyes P2 and the nose P3, the display data generation unit 105 may acquire image data corresponding to the facial contour P1, the eyes P2, the nose P3, and the mouth P4 from the painting-like converted image storing unit 114 and store it as the display data in the display data storing unit 115. The display control unit 35 controls the display unit 41 to display thereon the image of the facial contour P1 and the regions of the eyes P2, the nose P3, and the mouth P4 based on the display data stored in the display data storing unit 115.

Finally, the display data generation unit 105 acquires image data of the complete image P5 including the background from the painting-like converted image storing unit 114, following the facial contour P1, the eyes P2, the nose P3, and the mouth P4 of the painting-like converted image B2, and stores it along with the already acquired image data of the facial contour P1, the eyes P2, the nose P3, and the mouth P4, as the display data in the display data storing unit 115. Alternatively, instead of overlaying the image data of the complete image P5 including background on the image data of the facial contour P1, the eyes P2, the nose P3, and the mouth P4, the display data generation unit 105 may acquire image data of the complete image P5 including the facial contour P1, the eyes P2, the nose P3, the mouth P4, and the background from the painting-like converted image storing unit 114 and store it as the display data in the display data storing unit 115. The display control unit 35 controls the display unit 41 to display thereon the complete image P5 including the facial contour P1, the eyes P2, the nose P3, the mouth P4, and the background based on the display data stored in the display data storing unit 115. Thus, before the complete image is displayed, main parts of the image, for example, the characteristic regions such as the facial contour P1, the eyes P2, the nose P3, the mouth P4, and the complete image P5 are progressively displayed, thereby enabling effective presentation to the user of interesting information on the painting-like converted image B2, i.e., an image about to be displayed. With this, it becomes possible to attract the user's interest and attention to the image about to be displayed. Therefore, according to the photo frame 1 of the present embodiment, it is possible to display images in a sophisticated manner that can entertain the user.

The image data stored as display data in the display data storing unit 115 may be stored in the removable storage medium 51 in time series each time the display data is generated by the display data generation unit 105. With this, another display apparatus can display the images in a similar manner.

### [Flow of the Slideshow Processing]

When the operation mode is switched to the slideshow mode by an operation on the mode switch key, the CPU 31 controls various functions including the data processing unit 12 according to the program for slideshow mode stored in the ROM 32. In the following, the processing carried out in the slideshow mode will be described with focus on the processing when images are displayed.

Though the slideshow mode will be described hereinafter, it is not important whether any other images are displayed before or after an image is displayed in the slideshow mode. Only one image may be displayed in the slideshow mode at the beginning of, at the end of, or in the middle of a series of a plurality of images being displayed one after another.

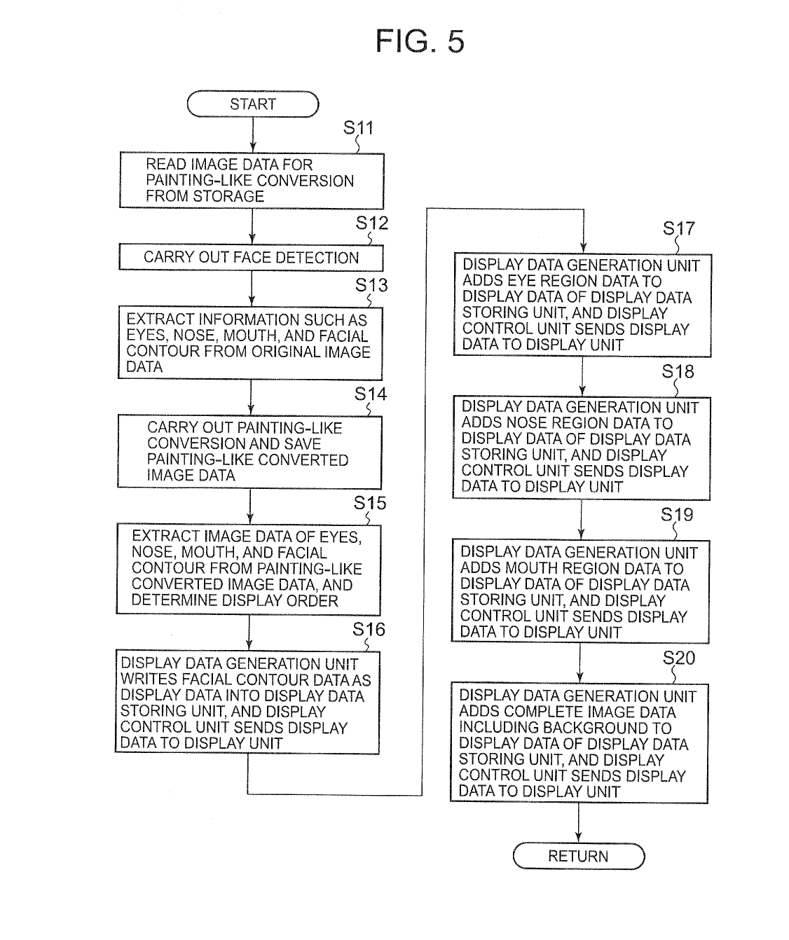

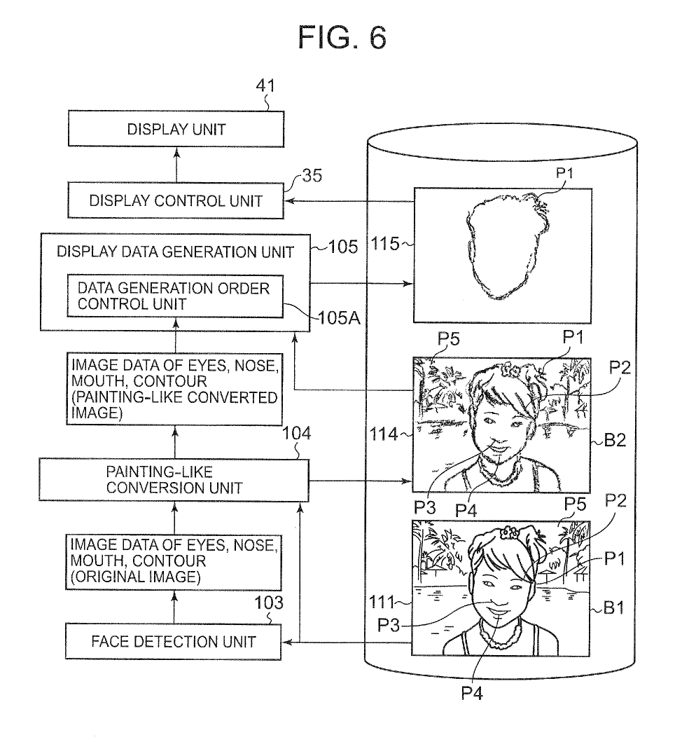

In the following, flow of processing for displaying an image including the painting-like conversion processing will be described with reference to FIGS. 5 and 6 and further with reference to FIG. 4. FIG. 5 is a flowchart explaining one example of flow of the slideshow processing including the painting-like conversion processing. FIG. 6 is a diagram showing relations between the function of each constituent unit of the data processing unit 12 and image generation in the slideshow format.

The processing shown below starts when a user operates on the mode switch key of the operation unit 43 to switch to the slideshow mode. Then the display control unit 35 repeatedly reads the display data stored in the display data storing unit 115 and causes the display unit 41 to display the display image based on the display data.

More specifically, the face detection unit 103 reads image data of the original image B1 on which the painting-like conversion processing is to be carried out, from among the image data stored in the initial frame storing unit 111 (step S11), carries out face detection (step S12), and extracts information on characteristic regions such as the facial contour P1, the eyes P2, the nose P3, and the mouth P4 therefrom (step S13). In the example of FIG. 6, the original image B1 is a picture of a girl. The face detection unit 103 extracts information on characteristic regions such as the facial contour P1, the eyes P2, the nose P3, and the mouth P4 from the image data of the original image B1 stored in the initial frame storing unit 111.

The painting-like conversion unit 104 carries out the painting-like conversion processing on the image data thus read and stores the image data thus acquired in the painting-like converted image storing unit 114 (step S14). In the example of FIG. 6, the painting-like conversion unit 104 generates image data of the painting-like converted image B2 characterized by the facial contour P1, the eyes P2, the nose P3, the mouth P4, the background included in the complete image P5, and the like and stores it in the painting-like converted image storing unit 114.

The display data generation unit 105 extracts image data of the characteristic regions such as the facial contour P1, the eyes P2, the nose P3, the mouth P4, and the complete image P5 from the painting-like converted image data stored in the painting-like converted image storing unit 114 based on the information on the characteristic regions such as the facial contour P1, the eyes P2, the nose P3, the mouth P4, and the complete image P5 acquired by the face detection unit 103. Also, the data generation order control unit 105A of the display data generation unit 105 determines progressive display order of the characteristic regions (step S15). In the present embodiment, the data generation order control unit 105A determines the progressive display order of the characteristic regions of the painting-like converted image according to the display style stored in the painting-like conversion contents storing unit 113. The display order determined by the data generation order control unit 105A in the present embodiment is as follows:

First, the facial contour P1 alone is displayed. Next, the region of the eyes P2 is incrementally displayed. Subsequently, the regions of the nose P3 and the mouth P4 are incrementally displayed. Finally, the complete image P5 including background is displayed.

The display data generation unit 105 extracts image data of the facial contour P1 of the painting-like converted image stored in the painting-like converted image storing unit 114 based on the information on the characteristic regions acquired by the face detection unit 103, generates the display data, and stores it in the display data storing unit 115. The display control unit 35 supplies to the display unit 41 the latest display data thus stored in the display data storing unit 115 and causes the display unit 41 to display the image of the facial contour P1 of the painting-like converted image (step S16). In the example of FIG. 6, the display data generation unit 105 first generates display data of the facial contour P1 and stores it in the display data storing unit 115. The display control unit 35 causes the display unit 41 to display the image of the facial contour P1 of the painting-like converted image of FIG. 3 based on the display data.

Subsequently, the display data generation unit 105 extracts image data of the region of the eyes P2 of the painting-like converted image stored in the painting-like converted image storing unit 114 based on the information on the characteristic regions acquired by the face detection unit 103, adds it to the display data stored in the display data storing unit 115, and thus updates the display data. The display control unit 35 supplies to the display unit 41 the latest display data thus updated in the display data storing unit 115 and causes the display unit 41 to display the image of the facial contour P1 and the eyes P2 of the painting-like converted image (step S17). In this way, the display control unit 35 causes the display unit 41 to display the image of the facial contour P1 and the eyes P2 of the painting-like converted image of FIG. 4 based on the display data.

Subsequently, the display data generation unit 105 extracts image data of the region of the nose P3 of the painting-like converted image stored in the painting-like converted image storing unit 114 based on the information on the characteristic regions acquired by the face detection unit 103, adds it to the display data stored in the display data storing unit 115, and thus updates the display data. The display control unit 35 supplies to the display unit 41 the latest display data thus updated in the display data storing unit 115 and causes the display unit 41 to display the image of the facial contour P1, the eyes P2, and the nose P3 of the painting-like converted image (step S18).

Subsequently, the display data generation unit 105 extracts image data of the region of the mouth P4 of the painting-like converted image stored in the painting-like converted image storing unit 114 based on the information on the characteristic regions acquired by the face detection unit 103, adds it to the display data stored in the display data storing unit 115, and thus updates the display data. The display control unit 35 supplies to the display unit 41 the latest display data thus updated in the display data storing unit 115 and causes the display unit 41 to display the image of the facial contour P1, the eyes P2, the nose P3, and the mouth P4 of the painting-like converted image (step S19). Thus, the display control unit 35 causes the display unit 41 to display the image shown in FIG. 4, to which the nose P3 and the mouth P4 of the painting-like converted image has been added, based on the display data.

Subsequently, the display data generation unit 105 extracts image data of the complete image P5 including a background of the painting-like converted image stored in the painting-like converted image storing unit 114 based on the information on the characteristic regions acquired by the face detection unit 103, adds it to the display data stored in the display data storing unit 115, and thus updates the display data. The display control unit 35 supplies to the display unit 41 the latest display data thus updated in the display data storing unit 115 and causes the display unit 41 to display the complete image P5 including the background of the painting-like converted image (step S20). In this way, the display control unit 35 causes the display unit 41 to display the complete image P5 including the background of the painting-like converted image shown in FIG. 4 based on the display data.

From the foregoing description, it is to be understood that the photo frame 1 of the present embodiment can progressively display characteristic regions of a painting-like converted image when the painting-like converted image is displayed as a new image. Therefore, before the painting-like converted image is completely displayed, the photo frame 1 of the present embodiment can effectively present to the user interesting information on the painting-like converted image, i.e., an image about to be displayed, and thereby attract the user's interest and attention to the painting-like converted image. Therefore, it is possible to display an image in a sophisticated manner that can entertain the user.

Although, the present embodiment describes a display method of progressively displaying characteristic regions of an image of image data, which is processed by the painting-like conversion processing, with reference to FIG. 4, the present embodiment is not limited to this, and various display methods can be employed.

For example, in a case in which an image of image data, which is not processed by the painting-like conversion processing, is to be displayed, the same display method can be employed in a manner such that characteristic regions of the image are progressively displayed.

More specifically, in such a case, “display original image only” is selected from among the contents of painting-like conversion processing stored in the painting-like conversion contents storing unit 113. The display data generation unit 105 extracts image data of characteristic regions from image data of an initial frame image, i.e., an original image, stored in the initial frame storing unit 111, which is not processed by the painting-like conversion processing, based on the position information on characteristic regions detected by the face detection unit 103. The display data generation unit 105 stores image data thus extracted for each characteristic region of the original image as display data in the display data storing unit 115. The display control unit 35 controls the display unit 41 based on the display data stored in the display data storing unit 115 to progressively display the characteristic regions of the original image. In this way, according to the present embodiment, even if data of an image is not processed by the painting-like conversion processing, since it is possible to progressively display main parts of the image according to characteristic regions before the complete image is displayed, it is possible to effectively present to the user interesting information on an image about to be displayed, and thereby attract the user's interest and attention to the image. Therefore, it is possible to display an image in a sophisticated manner that can entertain the user.

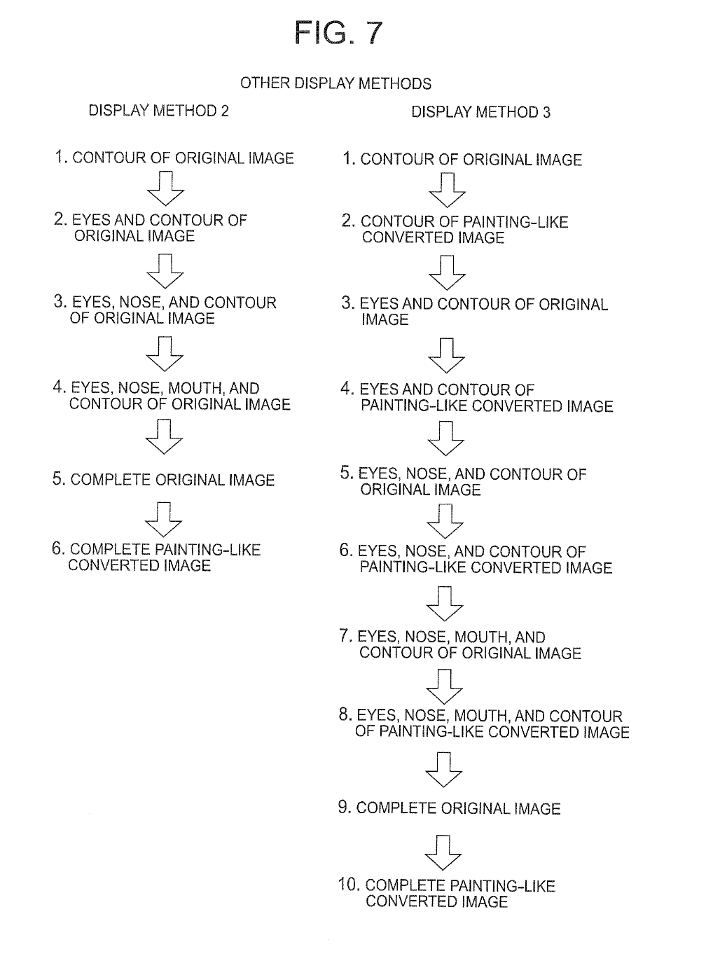

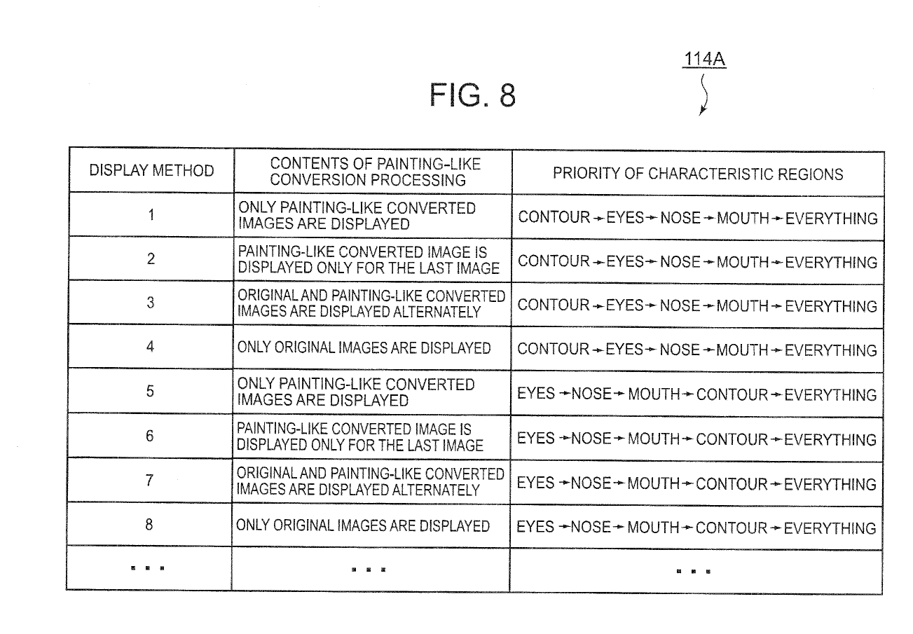

Also, in the case in which an image of image data, which is processed by the painting-like conversion processing, is displayed, various display methods other than the display method described with reference to FIG. 4 can be employed. FIG. 7 shows, as examples of other display methods, display method 2 and display method 3. In addition, FIG. 8 shows one example of the painting-like conversion processing contents table 114A stored in the painting-like conversion contents storing unit 113.

For example, in the display method 2 of FIG. 7, after characteristic regions of an original image of data, which is not processed by the painting-like conversion processing, are progressively displayed on the display unit 41, the painting-like converted image is displayed on the display unit 41. This means that, according to the display method 2 of FIG. 7, after the original image is displayed in the order of 1. contour, 2. eyes and contour, 3. eyes, nose, and contour, 4. eyes, nose, mouth, and contour, and 5. complete image on the display unit 41, then, 6. the complete painting-like converted image is displayed on the display unit 41.

More specifically, the display data generation unit 105 extracts image data of characteristic regions of the original image from the initial frame image data stored in the initial frame storing unit 111 based on the position information on characteristic regions detected by the face detection unit 103 and generates the display data in the order determined by the data generation order control unit 105A (in this case, in the order of 1. contour, 2. eyes and contour, 3. eyes, nose, and contour, 4. eyes, nose, mouth, and contour, 5. complete image). The display data generation unit 105 successively generates display data and each time the display data is generated, updates the display data stored in the display data storing unit 115 with the latest display date. The display data generation unit 105 finally generates as display data the image data of 6. the complete painting-like converted image and updates the display data stored in the display data storing unit 115 with the image data of 6.

The display control unit 35 controls the display unit 41 to display an image thereon based on the display data stored in the display data storing unit 115. As a result thereof, images are displayed on the display unit 41 in the order of the display method 2 of FIG. 7, i.e., 1. contour of the original image, 2. eyes and contour thereof, 3. eyes, nose, and contour thereof, 4. eyes, nose, mouth, and contour thereof, 5. the complete original image, and 6. the complete painting-like converted image.

Such content of a series of the painting-like conversion processing may be stored as “display method 2” in the painting-like conversion contents storing unit 113. With this, the user can only operate the operation unit 43 and select “display method 2” from the contents in the painting-like conversion contents storing unit 113. In this way, the user can display the image in a manner such that characteristic regions of an original image are progressively displayed, after which the complete painting-like converted image is displayed.

This means that in display method 2, based on image data of a plurality of characteristic regions extracted by the image data extracting unit from data of an original image and data of a painting-like converted image acquired by carrying out the painting-like conversion processing on the original image data, the display control unit 35 can execute an image display such that the characteristic regions of the original image are progressively displayed according to priority, after which the complete painting-like converted image is displayed. Since the main parts of the image can be progressively displayed using the characteristic regions of the original image, before the complete painting-like converted image is displayed, it is possible to effectively present interesting information on an image about to be displayed, and thereby attract the user's interest and attention to the painting-like converted image, i.e., the image about to be displayed. Therefore, it is possible to display an image in a sophisticated manner that can entertain the user.

Here, the painting-like conversion unit 104 may generate the painting-like converted image data by carrying out the painting-like conversion processing on the initial frame image data of the original image data stored in the initial frame storing unit 111 at any time so long as the display control 35 can cause the display unit 41 to appropriately display the complete painting-like converted image after the complete original image including background is displayed. For example, the painting-like conversion unit 104 may generate the painting-like converted image data in advance by carrying out the painting-like conversion processing on the initial frame image data of the original image and storing it into the painting-like converted image storing unit 114. Also, the painting-like conversion unit 104 may generate the painting-like converted image data by carrying out the painting-like conversion processing on the original image data stored either immediately before or immediately after the display control unit 35 has displayed the complete original image including the background, for example, so long as the display control 35 can cause the display unit 41 to appropriately display the painting-like converted image immediately after the complete original image including background is displayed.

In the display method 3 of FIG. 7, characteristic regions of an original image and a painting-like converted image are alternately and progressively displayed, and finally the complete painting-like converted image is displayed. This means that, according to the display method 3 of FIG. 7, images are displayed on the display unit 41 in the order of 1. contour of the original image, 2. contour of the painting-like converted image, 3. eyes and contour of the original image, 4. eyes and contour of the painting-like converted image, 5. eyes, nose, and contour of the original image, 6. eyes, nose, and contour of the painting-like converted image, 7. eyes, nose, mouth, and contour of the original image, 8. eyes, nose, mouth, and contour of the painting-like converted image, 9. the complete original image, and 10. the complete painting-like converted image.

More specifically, the painting-like conversion unit 104 first carries out the painting-like conversion processing on the initial frame image data of the original image and stores the generated painting-like converted image data in the painting-like converted image storing unit 114.

Next, the display data generation unit 105 extracts image data of characteristic regions both from the original image data stored in the initial frame storing unit 111 and the painting-like converted image data stored in the painting-like converted image storing unit 114 based on the position information on characteristic regions detected by the face detection unit 103 and generates the display data in the order determined by the data generation order control unit 105A. In this case, the display data is generated in the order of 1. contour of the original image, 2. contour of the painting-like converted image, 3. eyes and contour of the original image, 4. eyes and contour of the painting-like converted image, 5. eyes, nose, and contour of the original image, 6. eyes, nose, and contour of the painting-like converted image, 7. eyes, nose, mouth, and contour of the original image, 8. eyes, nose, mouth, and contour of the painting-like converted image, 9. the complete original image, and 10. the complete painting-like converted image. The display data generation unit 105 successively generates new display data and updates thereto the display data stored in the display data storing unit 115.

The display control unit 35 controls the display unit 41 to display thereon an image based on the display data stored in the display data storing unit 115. As a result thereof, images are displayed on the display unit 41 in the order of the display method 3 of FIG. 7, i.e., 1. contour of the original image, 2. contour of the painting-like converted image, 3. eyes and contour of the original image, 4. eyes and contour of the painting-like converted image, 5. eyes, nose, and contour of the original image, 6. eyes, nose, and contour of the painting-like converted image, 7. eyes, nose, mouth, and contour of the original image, 8. eyes, nose, mouth, and contour of the painting-like converted image, 9. the complete original image, and 10. the complete painting-like converted image.

Such contents of a series of the painting-like conversion processing may be stored as “display method 3” in the painting-like conversion contents storing unit 113. With this, the user can operate the operation unit 43 and select “display method 3” from the contents in the painting-like conversion contents storing unit 113. In this way, the user can display the image in a manner such that characteristic regions of an original image and a painting-like converted image are alternately and progressively displayed, and finally the complete painting-like converted image is displayed.

This means that, in the display method 3, based on image data of a plurality of characteristic regions of the original image and the painting-like converted image extracted by the image data extracting unit, an image display is possible such that, after the characteristic regions of the original image and the painting-like converted image are alternately and progressively displayed according to priority, the complete painting-like converted image is displayed. Since, the characteristic regions of the original image and the painting-like converted image can be alternately and progressively displayed before the complete painting-like converted image is displayed, it is possible to effectively present to the user interesting information on a painting-like converted image, i.e., an image about to be displayed and thereby attract the user's interest and attention to the image. Therefore, it is possible to display an image in a sophisticated manner that can entertain the user.

Here, although it has been described that the painting-like conversion unit 104 carries out the painting-like conversion processing on the original image data beforehand and stores the generated painting-like converted image data in the painting-like converted image storing unit 114, the painting-like conversion unit 104 may carry out the painting-like conversion processing on the original image data at any time so long as the display control 35 can appropriately display the original image and the painting-like converted image so that the characteristic regions of both images are alternately and progressively displayed. Furthermore, the painting-like conversion unit 104 may carry out the painting-like conversion processing on the image data of each characteristic region of the original image, instead of carrying out the painting-like conversion processing on the complete original image data. In this case as well, the painting-like conversion unit 104 may carry out the painting-like conversion processing on the complete original image data or on the image data of each characteristic region of the original image, for example, either immediately before or immediately after the display control unit 35 displays the characteristic region so long as the display control unit 35 can appropriately display the original image and the painting-like converted image so that the characteristic regions of both images are alternately and progressively displayed.

It should be noted that the present invention is not limited to the embodiment described above, and modifications and improvements thereto within a scope that can realize the object of the present invention are included in the present invention.

For example, in the embodiment described above, it has been explained, as an example, that characteristic regions are facial contour, eyes, nose, and mouth, which are detected by the face detection unit 103. However, the present invention is not limited to this. For example, buildings, landscapes, or the like, may be employed as characteristic regions so long as identification thereof is possible based on structure, color, or the like. In such cases, instead of the face detection unit 103, a preferable detection unit may be employed to detect such characteristic regions.

Furthermore, in the embodiment described above, a description has been given in which the image processing apparatus according to the present invention is configured by a photo frame having a slideshow function. However, the present invention is not limited to a photo frame having a slideshow function and can be applied to any electronic device. More specifically, the present invention can be applied to a digital camera, a portable navigation device, a portable game device, a projector, a TV (television set), an information processing apparatus that displays a captured image externally supplied from a digital camera, or any kind of image display apparatus.

The series of processing described above can be executed by hardware and also can be executed by software.

In a case in which the series of processing is executed by software, the program configuring the software is installed from a network or a storage medium to a computer or the like. The computer may be a computer incorporated in dedicated hardware. Alternatively, the computer may be capable of executing various functions by installing various programs, i.e., a general-purpose personal computer, for example.

The storage medium containing the program can be configured not only by the removable storage medium 51 distributed separately from the device main body for supplying the program to a user, but also by a storage medium or the like supplied to the user in a state incorporated in the device main body in advance. The removable storage medium may include a magnetic disk (including a floppy disk), an optical disk, a magnetic optical disk, or the like, for example. The optical disk may include a CD-ROM (Compact Disk-Read Only Memory), a DVD (Digital Versatile Disk), or the like. The magnetic optical disk may include an MD (Mini-Disk) or the like. The storage medium supplied to the user in a state where it is incorporated in the device main body in advance includes the ROM 32 of FIG. 1 storing the program, a hard disk 37, and the like, for example.

It should be noted that, in the present description, the step describing the program stored in the storage medium includes not only the processing executed in a time series following this order, but also includes processing executed in parallel or individually, which is not necessarily executed in a time series.

What is claimed is:

1. An image processing apparatus for causing an image to be displayed, the apparatus comprising:
a priority storing unit that stores priorities for a plurality of characteristic regions constituting an image;
an image data extracting unit that extracts image data of the plurality of characteristic regions from image data of an image; and
an image display control unit that controls an image display unit to progressively display the image in units of the characteristic regions, in accordance with priorities stored in the priority storing unit, based on the image data of the plurality of characteristic regions extracted by the image data extracting unit from the image data of the image.

2. An image processing apparatus as set forth in claim 1, wherein
the priority storing unit stores priorities for a plurality of characteristic regions constituting a face, as the plurality of characteristic regions;
the image data extracting unit carries out face detection processing, and extracts image data of the plurality of characteristic regions constituting the face, as image data of characteristic regions; and
the image display control unit controls the image display unit to progressively display the image in units of the characteristic regions constituting the face when the image is displayed, based on the plurality of characteristic regions constituting the face extracted by the image data extracting unit from the image data of the image.

3. An image processing apparatus as set forth in claim 1, wherein
the image data extracting unit carries out face detection processing, and extracts image data of at least a facial contour, as the image data of the characteristic region;
the priority storing unit stores the facial contour as a characteristic region of highest priority; and
the image display control unit controls the image display unit to firstly display the facial contour when the image is displayed, based on the image data of the facial contour extracted by the image data extracting unit from the image data of the image.

4. An image processing apparatus as set forth in claim 2, wherein
the image data extracting unit carries out face detection processing, and further extracts image data of at least regions of eyes, nose and mouth, as image data of characteristic regions;
the priority storing unit stores at least eyes, nose and mouth as characteristic regions in descending order of priority; and
the image display control unit controls the image display unit to progressively display the image in order of eyes, nose and mouth when the image is displayed, based on the image data of the eyes, nose, and mouth extracted by the image data extracting unit from the image data of the image.

5. An image processing apparatus as set forth in claim 1, further comprising a painting-like conversion unit that carries out painting-like conversion processing on an image and generates a painting-like converted image, wherein
the painting-like conversion unit carries out painting-like conversion processing on the image data of the image and generates image data of a painting-like converted image, and
the image display control unit controls the image display unit to progressively display the painting-like converted image in units of characteristic regions in accordance with priorities stored in the priority storing unit when the image is progressively displayed, based on the image data of the plurality of characteristic regions extracted by the image data extracting unit from the image data of the painting-like converted image generated by the painting-like conversion unit.

6. An image processing apparatus as set forth in claim 5, further comprising an image storing unit that stores image data of an image, wherein
the image storing unit stores image data of a painting-like converted image generated by the painting-like conversion unit carrying out painting-like conversion processing on the image data of the image, and image data of an original image, which is the image data on which the painting-like conversion unit has carried out painting-like conversion processing to generate the painting-like converted image;
the image data extracting unit extracts image data of the plurality of characteristic regions from image data of the original image stored in the image storing unit, and further extracts the image data of the painting-like converted image, and
the image display control unit causes to display the painting-like converted image after sequentially displaying the original image in units of the characteristic regions when the image is progressively displayed, based on the image data of the plurality of characteristic regions of the original image and the painting-like converted image extracted by the image data extracting unit.

7. An image processing apparatus as set forth in claim 5, further comprising an image storing unit that stores image data of an image, wherein
the image storing unit stores image data of a painting-like converted image generated by the painting-like conversion unit carrying out painting-like conversion processing on the image data of the image, and image data of an original image, which is the image data on which the painting-like conversion unit has carried out painting-like conversion processing to generate the painting-like converted image,
the image data extracting unit extracts image data of the plurality of characteristic regions from image data of the original image and the image data of the painting-like converted image stored in the image storing unit, respectively, and
the image display control unit, when the image is progressively displayed, causes to display a characteristic region corresponding to the painting-like converted image each time one characteristic region of the original image is displayed, based on the image data of the plurality of characteristic regions of the original image and of the painting-like converted image, respectively extracted by the image data extracting unit.

8. An image processing method for causing an image to be displayed, comprising:
a priority storing step of storing priorities for a plurality of characteristic regions constituting an image;
an image data extracting step of extracting image data of the plurality of characteristic regions from image data of an image; and
an image display control step of controlling an image display unit to progressively display the image in units of the characteristic regions, in accordance with priorities stored in the priority storing step, based on the image data of the plurality of characteristic regions extracted in the image data extracting step from the image data of the image.

9. A storage medium storing an image processing program causing a computer to control an image display unit to display an image, the program being executable by the computer to function as:
a priority storing unit that stores priorities for a plurality of characteristic regions constituting an image;
an image data extracting unit that extracts image data of the plurality of characteristic regions from image data of an image; and
an image display control unit that controls an image display unit to progressively display the image in units of the characteristic regions, in accordance with priorities stored in the priority storing unit, based on the image data of the plurality of characteristic regions extracted by the image data extracting unit from the image data of the image.
